(19) United States
(12) Patent Application Publication
(10) Pub. No.: US 2014/0086113 A1
(43) Pub. Date: Mar. 27, 2014

(54) METHOD AND APPARATUS FOR TRANSMITTING AND RECEIVING CONTROL CHANNEL IN DYNAMIC TIME DIVISION DUPLEX SYSTEM

(71) Applicant: Samsung Electronics Co., Ltd, Gyeonggi-do (KR)

(72) Inventors: Hyoung-Ju Ji, Seoul (KR); Joon-Young Cho, Gyeonggi-do (KR); Young-Bum Kim, Seoul (KR); Seung-Hoon Choi, Gyeonggi-do (KR)

(73) Assignee: Samsung Electronics Co., Ltd, Gyeonggi-do (KR)

(21) Appl. No.: 14/040,509

(22) Filed: Sep. 27, 2013

(30) Foreign Application Priority Data
Sep. 27, 2012 (KR) 10-2012-0107516

(51) Int. Cl. H04W 72/04

(52) U.S. Cl. CPC H04W 72/0406
USPC 370/280

(57) ABSTRACT

A method and system for transmitting and receiving a control channel in a dynamic Time Division Duplex (TDD) system. Upon receiving a control signal DCI for a first Hybrid Automatic Retransmission Request (HARQ) process from a Node B, a User Equipment (UE) determines whether TDD configuration is changed in a radio frame to which the DCI is to be applied. If the TDD configuration is changed, the UE determines from the DCI whether retransmission for the first HARQ process is required. If the retransmission required, the UE interprets some bits of a Modulation and Coding Scheme (MCS) field in the DCI as a target HARQ process index for the first HARQ process. As a result, the most is made of available UL data channel resources, contributing to an increase in the capacity of the dynamic TDD system and a reduction in packet delays of the UE.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Sep. 27, 2012 and assigned Serial No. 10-2012-0107516, the entire disclosure of which is incorporated herein by reference.

### TECHNICAL FIELD

The present disclosure relates generally to a communication system, and more particularly, to a method and apparatus for configuring a control channel in a dynamic Time Division Duplex (TDD) system.

### BACKGROUND

Mobile communication systems have been developed to provide communication while ensuring the mobility of users. Due to the rapid development of technology, the mobile communication systems have reached the phase of providing high-speed data communication services as well as the voice communication services.

In recent years, standardization for a Long Term Evolution (LTE) system, one of the next-generation mobile communication systems, is underway in 3rd Generation Partnership Project (3GPP). The LTE system is technology for implementing high-speed packet-based communication having a transfer rate of a maximum of about 100 Mbps, which is higher than the currently available data transfer rate, and for which standardization has been almost complete. In line with the completion of the LTE standardization, a discussion has been going on about an LTE-Advanced (LTE-A) system, a transfer rate of which is much improved by applying several new technologies to the LTE communication system. The term ‘LTE system’ will be construed to include both of the existing LTE system and the LTE-A system.

A control channel for a Time Division Duplex (TDD) system supporting Hybrid Automatic Retransmission Request (HARQ) is guaranteed the total number of supportable HARQ processes by the number of subframes configured for Uplink (UL) transmission. Therefore, a terminal or a User Equipment (UE) may continuously maintain or perform initial transmission and retransmission for UL data channels, the number of which corresponds to the total number of supportable HARQ processes. However, in the case of a dynamic TDD system, the number of UL subframes may be subject to change from time to time, as needed. If the total number of supportable HARQ processes varies from time to time in this way, pit may be difficult to ensure HARQ retransmission. In addition, in the case where a change in HARQ process cannot be exactly indicated, it is difficult for the UE to continue the previous HARQ process even though it has sufficient UL resources after switching the system. In this case, the UE needs to start again HARQ transmission from the beginning, causing unnecessary waste of resources and communication delays.

The above information is presented as background information only to assist with an understanding of the present disclosure. No determination has been made, and no assertion is made, as to whether any of the above might be applicable as prior art with regard to the present application.

### SUMMARY

To address the above-discussed deficiencies of the prior art, it is a primary object to provide a method and apparatus for transmitting and receiving information in a communication system.

Another aspect of the present disclosure is to provide a control channel configuring method and apparatus for continuing HARQ transmission without interruption in a TDD system in which UL resources may dynamically vary.

Another aspect of the present disclosure is to provide a method and apparatus for indicating a changed HARQ process index or a changed UL subframe index for a UE that requires retransmission during a change in UL resource configuration in a TDD system.

Another aspect of the present disclosure is to provide a method and apparatus for indicating changed HARQ process index information or changed UL subframe index information and retransmission version information, using the existing control channel in a dynamic TDD system.

In accordance with an aspect of the present disclosure, there is provided a method for transmitting a control channel in a dynamic Time Division Duplex (TDD) system. The method includes determining whether retransmission for a first Hybrid Automatic Retransmission Request (HARQ) process is required in a radio frame in which TDD configuration is changed; and if the retransmission is required, setting information used to instruct to switch the first HARQ process to a second HARQ process, in a control signal for retransmission of the first HARQ process, and transmitting the control signal to a User Equipment (UE).

In accordance with another aspect of the present disclosure, there is provided a method for receiving a control channel in a dynamic Time Division Duplex (TDD) system. The method includes receiving a control signal for a first Hybrid Automatic Retransmission Request (HARQ) process from a Node B; determining whether TDD configuration is changed in a radio frame to which the control signal is to be applied; if the TDD configuration is changed, determining from the control signal whether retransmission for the first HARQ process is required; and if the retransmission is required, interpreting predetermined bits of the control signal as information used to instruct to switch the first HARQ process to a second HARQ process.

In accordance with further another aspect of the present disclosure, there is provided a Node B apparatus for transmitting a control channel in a dynamic Time Division Duplex (TDD) system. The Node B apparatus includes a controller for determining whether retransmission for a first Hybrid Automatic Retransmission Request (HARQ) process is required in a radio frame in which TDD configuration is changed, and if the retransmission is required, setting information used to instruct to switch the first HARQ process to a second HARQ process, in a control signal for retransmission of the first HARQ process; a control channel generator for transmitting the control signal to a User Equipment (UE) using a control channel corresponding to the first HARQ process; and a data channel receiver for receiving retransmission data of the first HARQ process from the UE in a receive timing of the second HARQ process depending on the control signal.

In accordance with yet another aspect of the present disclosure, there is provided a User Equipment (UE) apparatus for receiving a control channel in a dynamic Time Division Duplex (TDD) system. The UE apparatus includes a control channel receiver for receiving a control signal for a first Hybrid Automatic Retransmission Request (HARQ) process from a Node B; a controller for determining whether TDD configuration is changed in a radio frame to which the control signal is to be applied, determining from the control signal whether retransmission for the first HARQ process is required, if the TDD configuration is changed, and interpreting predetermined bits of the control signal as information used to instruct to switch the first HARQ process to a second HARQ process, if the retransmission is required; and a data channel transmitter for transmitting retransmission data of the first HARQ process to the Node B in a transmit timing of the second HARQ process depending on the control signal.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a Downlink (DL) subframe according to an exemplary embodiment of the present disclosure;

FIG. 2 illustrates an HARQ transmission procedure for a data channel according to an exemplary embodiment of the present disclosure;

FIG. 3 illustrates a change in UL/DL configuration in a dynamic TDD system according to an exemplary embodiment of the present disclosure;

FIG. 4 illustrates a retransmission scenario for a data channel in a dynamic TDD system according to an exemplary embodiment of the present disclosure;

FIG. 5 illustrates a retransmission scenario for a data channel in a dynamic TDD system according to another exemplary embodiment of the present disclosure;

FIG. 6 illustrates a retransmission procedure for a data channel according to an exemplary embodiment of the present disclosure;

FIG. 7 illustrates operation of a Node B according to an exemplary embodiment of the present disclosure;

FIG. 8 illustrates operation of a UE according to an exemplary embodiment of the present disclosure;

FIG. 9 illustrates a block diagram of a structure of a Node B apparatus according to an exemplary embodiment of the present disclosure; and

FIG. 10 illustrates a block diagram of a structure of a UE apparatus according to an exemplary embodiment of the present disclosure.

Throughout the drawings, like reference numerals will be understood to refer to like parts, components, and structures.

### DETAILED DESCRIPTION

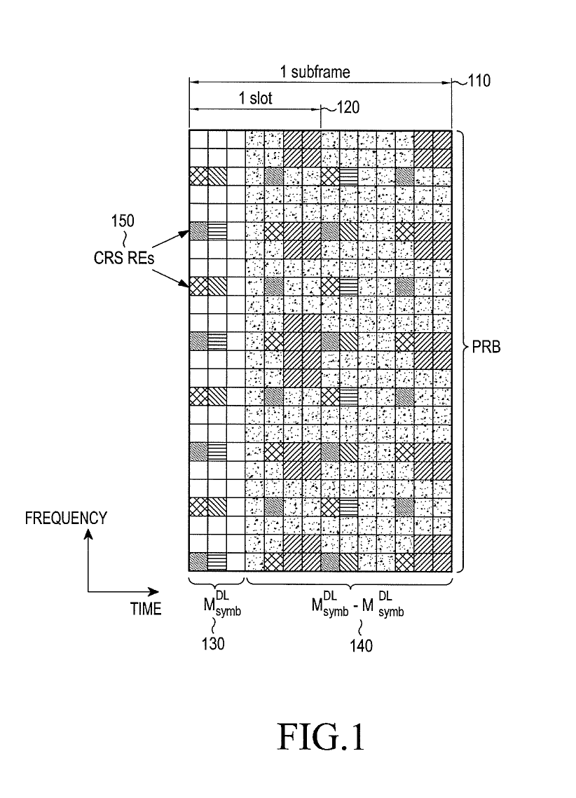

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. The following description with reference to the accompanying drawings is provided to assist in a comprehensive understanding of exemplary embodiments of the disclosure as defined by the claims and their equivalents. The present disclosure includes various specific details to assist in that understanding but these are to be regarded as merely exemplary. Accordingly, those of ordinary skilled in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The below-described exemplary embodiments of the present disclosure are for a communication system in which a base station or a Node B transmits a Downlink (DL) signal to a terminal or User Equipment (UE), and a UE transmits an Uplink (UL) signal to a Node B. In a Time Division Duplex (TDD) system, DL transmission and UL transmission are separated in the time domain. For example, the TDD system divides a radio frame comprised of a predetermined number of subframes into DL subframes for DL transmission and UL subframes for UL transmission. The transmission direction (i.e., DL or UL) of each subframe, and the number of DL and UL subframes may be determined by the system.

A DL signal includes a data channel including information desired to be transmitted to a UE, a control channel carrying a control signal, and a Reference Signal (RS) used for channel estimation and channel feedback. As an example, a Node B transmits data and a control signal to a UE using a Physical Downlink Shared Channel (PDSCH) and a Downlink Control Channel (DL CCH), respectively. A UL signal includes a data channel, a control channel and a reference signal transmitted by a UE. As an example, a UE transmits UL data using a Physical Uplink Shared Channel (PUSCH), and transmits a UL control signal using a Physical Uplink Control Channel (PUCCH).

The Node B may operate a variety of reference signals, including a Common Reference Signal (CRS), a Channel State Information RS (CSI-RS), and a UE-specific Reference Signal (i.e., Demodulation Reference Signal (DMRS)). The CRS is transmitted over the full DL band, and used for signal demodulation and channel estimation by all UEs in a cell. To reduce resources used for CRS transmission, the Node B transmits the DMRS in a region scheduled for a UE as a UE-specific reference signal, and to obtain channel state information, the Node B transmits the CSI-RS in the time and frequency domains.

FIG. 1 illustrates a structure of a DL subframe according to an exemplary embodiment of the present disclosure.

Referring to FIG. 1, a DL subframe 110 is a scheduling unit of a Node B, and each subframe 110 may include two slots 120. In the time domain, the subframe 110 may include a total of N_{symb}^{DL} Orthogonal Frequency Division Multiplexing (OFDM) symbols to transmit or carry a control channel signal, a data channel signal, and a reference signal. In each subframe 110, M_{symb}^{DL} leading symbols 130 may be used to transmit a control channel, and the remaining (N_{symb}^{DL}-M_{symb}^{DL}) symbols 140 may be used for transmission of a data channel.

A transmission bandwidth, in which the DL subframe 110 is carried, is comprised of Resource Blocks (RBs) in the frequency domain, and each RB may include a total of N_{sc}^{RB} subcarriers or Resource Elements (REs) in the frequency domain. A unit comprised of two slots and one RB will be called a Physical RB (PRB) pair. In one PRB pair may be transmitted a CRS 150, a CSR-RS, and a DMRS.

Table 1 below illustrates an example of a configuration of a radio frame in a TDD system.

TABLE 1

| | DL-to-UL | | | | | | | | | | |
|---|---|---|---|---|---|---|---|---|---|---|---|
| | Switch- | | | | | | | | | | |
| UL/DL | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Table 1 shows seven types of subframe configurations, and as for a radio frame comprised of ten subframes, a transmission direction of each subframe may be determined by one of the configurations in Table 1. In the table, ‘D’ represents DL transmission, ‘U’ represents UL transmission, and ‘S’ represents a special subframe in which some symbols are used for DL transmission and the remaining symbols are used for UL transmission. Generally, the special subframe may be used for transmission of a DL control channel and a DL data channel, but may not be used for UL transmission.

A Node B may use Dedicated Control Information (DCI) as a control signal for scheduling of a DL data channel or a UL data channel. Although not described in detail, a DCI for other purposes may be transmitted for delivery of system information, for initial access, and for control of UE power. A DCI format for scheduling may include Cyclic Redundancy Check (CRC) bits, allowing a UE to determine the DCI that is transmitted to the UE itself. Typically, the Node B may assign a Cell-Radio Network Temporary Identifier (C-RNTI), which is a temporary ID for scheduling, to a UE, scramble the C-RNTI in a CRC of a DCI for the UE, and transmit the scrambled C-RNTI in the CRC of the DCI to the UE. Depending on transmission purpose, the RNTI may be classified into an RNTI for transmission of system information, an RNTI for initial access, and an RNTI for paging.

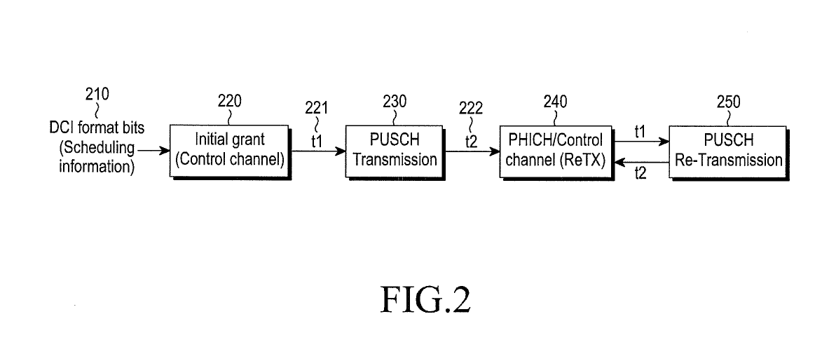

FIG. 2 illustrates an HARQ transmission procedure for a data channel according to an exemplary embodiment of the present disclosure.

Referring to FIG. 2, to start a UL HARQ process, a Node B may transmit a control signal DCI 210 containing scheduling information for a grant of initial data transmission, to a UE using a CCH 220. Upon receiving the DCI 210, the UE may transmit a UL data channel PUSCH 230 after a lapse of a predetermined time t1 221 since the reception of the DCI. The time t1 is determined taking into account the time required by a UE to make and transmit a data channel upon receiving scheduling information.

Upon receiving UL data from the UE using the PUSCH 230, the Node B may transmit an Acknowledgement (ACK)/Negative ACK (NACK), which is a response to the UL data, using a Physical HARQ Indicator Channel (PHICH) 240 after a lapse of a predetermined time t2 222 since the reception of the PUSCH. If retransmission is required, the Node B may configure a DCI for retransmission and transmit the DCI to the UE together with the response. The time t2 222 is determined taking into account the time required by a Node B to configure a response signal upon receiving data from a UE. The UE may retransmit UL data using a PUSCH 250 after a lapse of a time t1 since the reception of the ACK/NACK and DCI 240. If additional retransmission is required, the Node B and the UE may repeat the data channel transmission 250 and the control channel transmission 240 within a predetermined maximum number of retransmissions.

The time t1 221 and the time t2 222 may be defined differently depending the configurations of the radio frame illustrated in Table 1, because positions of UL subframes are different in different configurations of the radio frame.

Tables 2 and 3 below illustrate values of t1 and values of t2 depending on TDD UL/DL configurations of a radio frame.

TABLE 2

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

TABLE 3

| TDD UL/DL | subframe number i | | | | | | | | | |
|---|---|---|---|---|---|---|---|---|---|---|
| Configuration | 0 | 1 | 2 | 3 | 4 | 5 | 6 | 7 | 8 | 9 |
| 0 | 7 | 4 | | | | 7 | 4 | | | |
| 1 | | 4 | | | 6 | | 4 | | | 6 |
| 2 | | | | 6 | | | | | 6 | |
| 3 | 6 | | | | | | | | 6 | 6 |
| 4 | | | | | | | | | 6 | 6 |
| 5 | | | | | | | | | 6 | |
| 6 | 6 | 4 | | | | 7 | 4 | | | 6 |

Table 2 means that on the basis of a subframe number n for a subframe in which a control channel DCI is transmitted, a UL data channel PUSCH for a control channel received in an n-th subframe is transmitted in an (n+t1)-th subframe. Table 3 means that on the basis of a subframe number i for a subframe in which a PHICH or a retransmission control channel is transmitted, an ACK/NACK or DCI in an i-th subframe is a response to UL data channel generated in an (i−t2)-th subframe.

In the TDD system supporting HARQ transmission, a plurality of HARQ processes may be simultaneously operated depending on the number of UL subframes defined according to each TDD configuration. The number of UL HARQ processes defined according to the TDD configuration of Table 1 may be as shown in Table 4 below.

TABLE 4

| TDD UL/DL | Number of HARQ processes for |
|---|---|
| configuration | normal HARQ operation |
| 0 | 7 |
| 1 | 4 |
| 2 | 2 |
| 3 | 3 |
| 4 | 2 |
| 5 | 1 |
| 6 | 6 |

UL HARQ processes correspond to UL subframes in a radio frame, and a unique number of each HARQ process is identical to a unique number of the corresponding UL subframe. A UE may execute one to seven UL HARQ processes depending on the TDD configuration, and each HARQ process may perform HARQ transmission independently.

Table 5 below illustrates key information fields of a control channel (i.e., a DCI format) for scheduling of UL data channels in the TDD system.

TABLE 5

| Type | Information | Size (bits) |
|---|---|---|
| CIF | Carrier indication field | 3 |
| RA | Resource allocation field | Variable |
| MCS | MCS index | 5 |
| NDI | New data indication | 1 |
| TPC | Power command | 2 |
| CS | Cyclic shift | 3 |

In Table 5, a Carrier Indication Field (CIF) field indicates a carrier in which a UL data channel is transmitted. A Resource Allocation (RA) field indicates resources allocated to a UL data channel. A Modulation and Coding Scheme (MCS) field indicates an MCS index. A New Data Indication (NDI) field indicates whether a UL data channel is for initial transmission or retransmission. A Transmit Power Command (TPC) field indicates transmit power. A Cyclic Shift (CS) field indicates a CS value applied to a UL data channel. The NDI is comprised of a 1-bit value that is toggled each time UL data undergoes initial transmission. If a value of NDI is different from the previous value, a UE starts an HARQ process for new data, determining that the previous UL data has been successfully received at a Node B. On the other hand, if a value of NDI is the same as the previous value, the UE transmits retransmission data in the same HARQ process, determining that the Node B has failed to receive the previous UL data.

The MCS field may indicate the coding rate of a UL data channel, and may additionally indicate a Redundancy Version (RV) for indicating a retransmission version of an HARQ process. In other words, in the MCS field are jointly coded the coding rate and the RV. Table 6 below illustrates an example of joint coding for an MCS field.

TABLE 6

| MCS Index | Modulation Order | TBS Index | Redundancy Version |
|---|---|---|---|
| I_{MCS} | Q′ₘ | I_{TBS} | rv_{idx} |
| 0 | 2 | 0 | 0 |
| 1 | 2 | 1 | 0 |
| 2 | 2 | 2 | 0 |
| 3 | 2 | 3 | 0 |
| 4 | 2 | 4 | 0 |
| 5 | 2 | 5 | 0 |
| 6 | 2 | 6 | 0 |
| 7 | 2 | 7 | 0 |
| 8 | 2 | 8 | 0 |
| 9 | 2 | 9 | 0 |
| 10 | 2 | 10 | 0 |
| 11 | 4 | 10 | 0 |
| 12 | 4 | 11 | 0 |
| 13 | 4 | 12 | 0 |
| 14 | 4 | 13 | 0 |
| 15 | 4 | 14 | 0 |
| 16 | 4 | 15 | 0 |
| 17 | 4 | 16 | 0 |
| 18 | 4 | 17 | 0 |
| 19 | 4 | 18 | 0 |
| 20 | 4 | 19 | 0 |
| 21 | 6 | 19 | 0 |
| 22 | 6 | 20 | 0 |
| 23 | 6 | 21 | 0 |
| 24 | 6 | 22 | 0 |
| 25 | 6 | 23 | 0 |
| 26 | 6 | 24 | 0 |
| 27 | 6 | 25 | 0 |
| 28 | 6 | 26 | 0 |

| | | |
|---|---|---|
| 29 | Reserved | 1 |
| 30 | | 2 |
| 31 | | 3 |

In Table 6, Modulation Order indicates a modulation scheme, for example, Binary Phase Shift Keying (BPSK), Quadrature PSK (QPSK), 16-ary Quadrature Amplitude Modulation (16-QAM), and 64-ary QAM (64-QAM), and a Transport Block Size (TBS) index I_{TBS} indicates the amount of information desired to be transmitted in one PRB. The modulation order and the TBS index may correspond to the coding rate. RV index rv_{idx} represents configuration of the data desired to be transmitted. In other words, for retransmission of the same data, a UE may configure retransmission data including different coding bits depending on the RV index.

As illustrated in Table 6, if a Node B changes the modulation order and the TBS index for retransmission, the RV is maintained at zero (0). When the Node B desires to instruct a UE to transmit data of an RV different from that used in the previous transmission, bits for the modulation order and the TBS index are meaningless, so the modulation scheme and the TBS index during retransmission may be maintained in the same way as in the previous transmission.

Since the DL supports asynchronous HARQ, a DL DCI needs to include an HARQ process number (i.e., a DL subframe number) for indicating initial transmission and retransmission points. A scheduler may determine the points of time the initial transmission and retransmission are performed, and provide information about HARQ process numbers of the points to a UE using a DL DCI. On the other hand, in the UL, since synchronous HARQ is operated, initial transmission and retransmission points are determined depending on the transmission time (or point) of the relevant control information, so a UL DCI includes no HARQ process number. Depending on the point at which a DCI is received, a UE may determine the point (i.e., an HARQ process number) at which the UE's associated initial transmission or retransmission is performed. In the TDD system, for all HARQ processes, since their initial transmission and retransmission are determined at different points, a UE may automatically distinguish the HARQ process on the basis of a subframe in which initial transmission started.

In the TDD system, if the configuration of a radio frame remains unchanged, the system performance may be degraded as the DL and the UL may vary in terms of the amount of data. As an example, if the amount of DL data desired to be transmitted increases during the use of TDD UL/DL configuration #1 in which a larger amount of data may be transmitted in the UL as defined in Table 1, the TDD UL/DL configuration #1 cannot afford the increased amount of DL transmission data.

In order to avoid these problems, the configuration of a radio frame may be dynamically changed according to the required amount of DL and UL data at stated intervals, for example, at intervals of 10-msec radio frames. This system is called a dynamic TDD system.

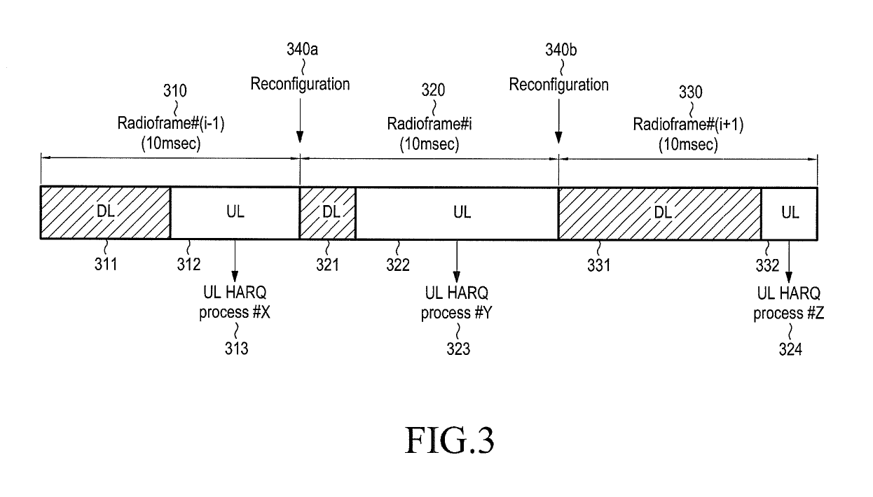

FIG. 3 illustrates a change in UL/DL configuration in a dynamic TDD system according to an exemplary embodiment of the present disclosure.

Referring to FIG. 3, reference numerals 310, 320 and 330 show radio frames in time order. Reference numeral 310 represents an (i−1)-th radio frame, reference numeral 320 represents an i-th radio frame, and reference numeral 330 represents an (i+1)-th radio frame. In the dynamic TDD system, after the (i−1)-th radio frame 310, reconfiguration information 340a for instructing a change in radio frame configuration is transmitted by a Node B. While a DL resource 311 is similar in size to a UL resource 312 in the (i−1)-th radio frame 310, a DL resource 321 may be smaller in size than a UL resource 322 in the i-th radio frame 320 due to the reconfiguration information 340a. In the (i+1)-th radio frame 330, a DL resource 331 may be changed to be larger in size than a UL resource 332 due to reconfiguration information 340b after the i-th radio frame 320.

If a UE may operate X UL HARQ processes 313 in the (i−1)-th radio frame 310, Y UL HARQ processes 323 in the i-th radio frame 320, and Z UL HARQ processes 324 in the (i+1)-th radio frame 330, the number of UL HARQ processes operable in the UE may vary to have a relationship of Z<X<Y.

As mentioned above, in the dynamic TDD system, if a TDD configuration is changed, the number of available UL HARQ processes may increase or decrease. If the number of UL HARQ processes increases, the UE may continuously support retransmission of the UL HARQ process in the next radio frame, regardless of whether retransmission is not required as a specific UL HARQ process of the previous radio frame has succeeded in transmission, or whether retransmission is required, because UL HARQ processes of the previous radio frame may continuously remain in the next radio frame after reconfiguration or after a change in configuration. However, if the number of UL HARQ processes decreases, at least one HARQ process may be interrupted in some cases.

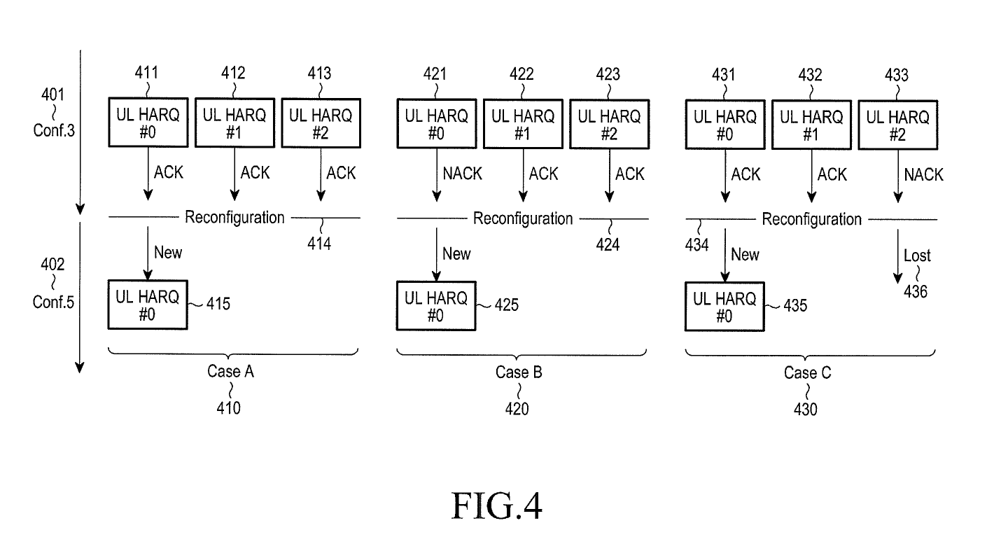

FIG. 4 illustrates a retransmission scenario for a data channel in a dynamic TDD system according to an exemplary embodiment of the present disclosure. It will be assumed that while TDD configuration #3 (in which the number of available UL HARQ processes is 3) defined in Table 1 is used in an (i−1)-th radio frame 401, the TDD configuration is switched to TDD configuration #5 (in which the number of available UL HARQ processes is 1) in an i-th radio frame 402.

Referring to FIG. 4, while the (i−1)-th radio frame 401 may support three UL HARQ processes defined based on configuration #3 401, the i-th radio frame 402 may support only one UL HARQ process. In this case, three possible scenarios 410, 420 and 430 may occur.

According to the first scenario 410, as all of three UL HARQ processes 411, 412 and 413 that a UE was operating in the (i−1)-th radio frame 401 have succeeded in transmission, the UE may perform initial transmission on new data in one UL HARQ process 415 available in the i-th radio frame 402 after reconfiguration 414. In other words, since retransmission is not required despite the change in TDD configuration, all UL resources may be used without problems even after the reconfiguration.

According to the second scenario 420, among the three UL HARQ processes 421, 422 and 423 that the UE was operating in the (i−1)-th radio frame 401, the second and third HARQ processes 422 and 423 have succeeded in transmission, but the first HARQ process 421 requires retransmission as the first HARQ process 421 has failed in transmission. In this case, retransmission by the first UL HARQ process 421 may succeed to the first UL HARQ process 425 after reconfiguration 424 (or after a change in TDD configuration). However, if a DL subframe capable of transmitting a control channel for instructing retransmission of the UL HARQ process 425 does not exist in the i-th radio frame 402, the HARQ operation may not undergo succession.

According to the third scenario 430, among the three UL HARQ processes 431, 432 and 433 that the UE was operating in the (i−1)-th radio frame 401, the first and second HARQ 431 and 432 have succeeded in transmission, but the last HARQ process 433 requires retransmission as they have failed in transmission. In this case, since the third HARQ process 433 may no longer exist after reconfiguration 434, the HARQ process 433 may no longer last or may be lost (see 436). Then, the UE needs to try again data transmission of the HARQ process 433 from the beginning in a newly generated HARQ process 435. However, if even the first HARQ process 431 before reconfiguration 434 requires retransmission, the HARQ process 433 may need to be terminated. Similarly, if a DL subframe used for a control channel capable of instructing initial transmission of the HARQ process 435 does not exist in the i-th radio frame 402, the HARQ process 435 may not be initiated.

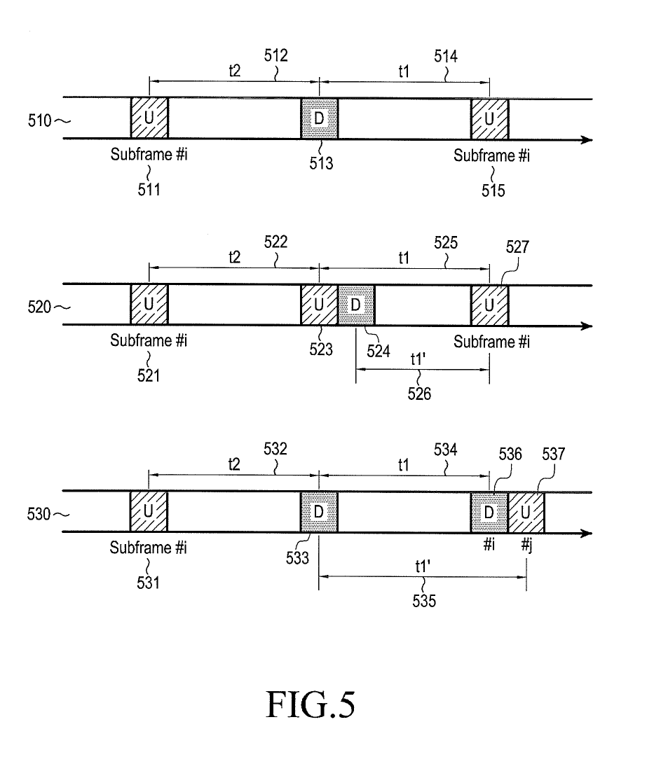

FIG. 5 illustrates a retransmission scenario for a data channel in a dynamic TDD system according to another exemplary embodiment of the present disclosure. This drawing shows a possible problem in the time axis, which may occur if an HARQ process continues between different TDD UL/DL configurations.

Referring to FIG. 5, reference numeral 510 shows the general UL HARQ transmission. If an error occurs in a UL data channel of a specific HARQ process, which is transmitted in a subframe #i 511 of an n-th radio frame, transmission of a response channel for requesting retransmission for the defective channel and a retransmission control channel may take place in a DL subframe 513 after a lapse of a predetermined time t2 512. Thereafter, retransmission of the HARQ process may take place in a subframe #i 515 of an (n+1)-th radio frame.

If the TDD UL/DL configuration is changed after the DL subframe 513, retransmission of the HARQ process may be continuously performed even after the change in TDD UL/DL configuration, since a transmission point 513 of a control channel for the HARQ process is ahead of the subframe #i 515 of the (n+1)-th radio frame by a time t1 514.

Reference numeral 520 shows an example of UL HARQ transmission in a problematic situation. If an error occurs in a UL data channel of a specific HARQ process, which is transmitted in a subframe #i 521 of an n-th radio frame, transmission of a response channel for requesting retransmission for the defective channel and a retransmission control channel should take place in a subframe 523 after a lapse of a predetermined time t2 522. However, if the subframe #i 521 is changed to a UL subframe as the TDD UL/DL configuration is changed before the subframe 523, transmission of a control channel for an HARQ process after the change in TDD UL/DL configuration, which corresponds to the HARQ process, may take place in another subframe 524. Since a time t1′ 526 from the subframe 524 to a subframe #i 527 of an (n+1)-th radio frame is shorter than a time t1 525 for the preparation for retransmission, retransmission of the HARQ process may not take place in the subframe #i 527. Therefore, the HARQ process, which was conducted in the n-th radio frame, may not be continuously maintained after the change in TDD UL/DL configuration.

Reference numeral 530 shows an example of UL HARQ transmission in another problematic situation. If an error occurs in a UL data channel of a specific HARQ process, which is transmitted in a subframe #i 531 of an n-th radio frame, transmission of a response channel for requesting retransmission for the defective channel and a retransmission control channel may take place in a subframe 533 after a lapse of a predetermined time t2 532. A control channel of the subframe 533 instructs transmission of a data channel in a subframe #i 536 of an (n+1)-th radio frame after a lapse of a predetermined time t1 534.

However, if the subframe #i 536 is changed to a DL subframe as the TDD UL/DL configuration is changed after the subframe 533, retransmission of the HARQ process may not take place, even though an available HARQ process resource exists in another UL subframe #j 537 after a lapse of an interval t1′ 535 which is sufficient for the preparation for retransmission (t1′>t1). This is because the UE has received no information about the subframe #j 537.

In the below-described exemplary embodiment of the present disclosure, if the TDD UL/DL configuration is changed, a Node B may provides information about the changed HARQ process using a retransmission control channel for a UE. To this end, the Node B may allow the UE to maintain the coding rate used in previous transmission, during retransmission caused by the change in TDD UL/DL configuration for UE.

Specifically, in an exemplary embodiment of the present disclosure, the coding rate for retransmission may be maintained to be the same as that of a data channel, which was used in previous transmission, so an MCS field may be used to indicate an HARQ process index and an RV. If a control channel, which is received after a UE detects a change in TDD UL/DL configuration, requires retransmission, i.e., if an NDI in the control channel is the same as an NDI in the previously received control channel as the NDI is not toggled, the UE may interpret an MCS field received in the current control channel as indicating an HARQ process index in the changed radio frame and an RV used for retransmission. Therefore, a position of an HARQ process of a data channel for retransmission may be changed to a value indicated by the MCS field.

On the other hand, if a control channel, which is received after the TDD UL/DL configuration is changed, indicates initial transmission, i.e., if an NDI is different from an NDI in the previously received control channel as the NDI is toggled, the UE may interpret an MCS field in the currently received control channel as a coding, rate (for example, a modulation order) for initial transmission, and a TBS index.

Table 7 below illustrates interpretation for an MCS field of a control channel according to a first exemplary embodiment of the present disclosure.

TABLE 7

| MCS Index | | Redundancy Version |
|---|---|---|
| I_{MCS} | HARQ index | rv_{idx} |
| 0 | 0 | 0 |
| 1 | 1 | 0 |
| 2 | 2 | 0 |
| 3 | 3 | 0 |
| 4 | 4 | 0 |
| 5 | 5 | 0 |
| 6 | 6 | 0 |
| 7 | 0 | 1 |
| 8 | 1 | 1 |
| 9 | 2 | 1 |
| 10 | 3 | 1 |
| 11 | 4 | 1 |
| 12 | 5 | 1 |
| 13 | 6 | 1 |
| 14 | 0 | 2 |
| 15 | 1 | 2 |
| 16 | 2 | 2 |
| 17 | 3 | 2 |
| 18 | 4 | 2 |
| 19 | 5 | 2 |
| 20 | 6 | 2 |
| 21 | 0 | 3 |
| 22 | 1 | 3 |
| 23 | 2 | 3 |
| 24 | 3 | 3 |
| 25 | 4 | 3 |
| 26 | 5 | 3 |
| 27 | 6 | 3 |
| 28 | Reserved | 0 |
| 29 | Reserved | 1 |
| 30 | Reserved | 2 |
| 31 | Reserved | 3 |

If a control channel, which is first received after the TDD UL/DL configuration is changed, indicates retransmission, the UE may determine that among five bits of the MCS field, the first three bits indicate an HARQ process index and the last two bits indicate an RV. The HARQ process index means an HARQ process that uses the same subframe index. Therefore, non-consecutive HARQ process indexes may be used depending on the positions of UL subframes defined based on the TDD configuration.

For example, in the case of TDD UL/DL configuration #2 shown in Table 1, third and sixth subframes are used for the UL, so there are UL HARQ process indexes #0 and #1. In the case of TDD UL/DL configuration #3, only third, fourth and fifth subframes are used for the UL, so there are UL HARQ process indexes #0, #1 and #2. The HARQ process indexes have their associated UL subframe indexes.

In an alternative embodiment of the present disclosure, a coding rate for retransmission is maintained to be the same as that of a data channel used in the previous transmission, so an MCS field is used to transmit a UL subframe index and an RV. If a control channel, which is received after a UE detects a change in TDD UL/DL configuration, requires retransmission, i.e., if an NDI is the same as an NDI in the previously received control channel as the NDI is not toggled, the UE may interpret an MCS field received in the current control channel as indicating a UL subframe index in the changed radio frame and an RV used for retransmission. Therefore, a position of a UL subframe of a data channel for retransmission may be changed by information indicated by the MCS field.

On the other hand, if a control channel, which is received after the TDD configuration is changed, indicates initial transmission, i.e., if an NDI is different from an NDI in the previously received control channel as the NDI is toggled, the UE may interpret an MCS field in the currently received control channel as a coding, rate (for example, a modulation order) for initial transmission, and a TBS index.

Table 8 below illustrates interpretation for an MCS field of a control channel according to a second exemplary embodiment of the present disclosure.

TABLE 8

| MCS Index | UL subframe | Redundancy Version |
|---|---|---|
| I_{MCS} | index | rv_{idx} |
| 0 | 0 | 0 |
| 1 | 0 | 1 |
| 2 | 0 | 2 |
| 3 | 0 | 3 |
| 4 | 1 | 0 |
| 5 | 1 | 1 |
| 6 | 1 | 2 |
| 7 | 1 | 3 |
| 8 | 2 | 0 |
| 9 | 2 | 1 |
| 10 | 2 | 2 |
| 11 | 2 | 3 |
| 12 | 3 | 0 |
| 13 | 3 | 1 |
| 14 | 3 | 2 |
| 15 | 3 | 3 |
| 16 | 4 | 0 |
| 17 | 4 | 1 |
| 18 | 4 | 2 |
| 19 | 4 | 3 |
| 20 | 5 | 0 |
| 21 | 5 | 1 |
| 22 | 5 | 2 |
| 23 | 5 | 3 |
| 24 | 6 | 0 |
| 25 | 6 | 1 |
| 26 | 6 | 2 |
| 27 | 6 | 3 |
| 28 | Reserved | 0 |
| 29 | Reserved | 1 |
| 30 | Reserved | 2 |
| 31 | Reserved | 3 |

If a control channel, which is first received after the TDD UL/DL configuration is changed, indicates retransmission, the UE may determine that among five bits of the MCS field, the first three bits indicate a UL subframe index and the last two bits indicate an RV. The UL subframe index is a value that is sequentially assigned to each of UL subframes represented in one radio frame.

For example, in the case of TDD UL/DL configuration #2 shown in Table 1, third and sixth subframes are used for the UL, so there are UL subframe indexes #0 and #1. In the case of TDD UL/DL configuration #3, only third, fourth and fifth subframes are used for the UL, so there are UL subframe indexes #0, #1 and #2. The UL subframe indexes have their associated HARQ process indexes.

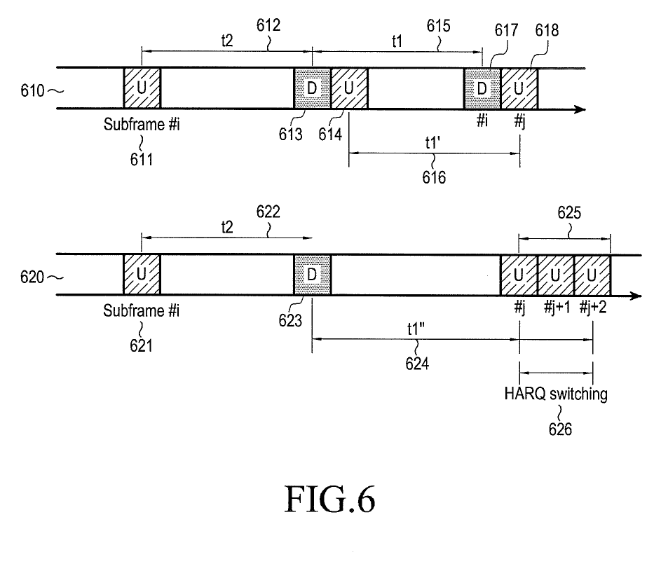

FIG. 6 illustrates a retransmission procedure for a data channel according to an exemplary embodiment of the present disclosure.

Referring to FIG. 6, reference numeral 610 shows a problematic situation which may occur if TDD configuration is changed during transmission of a UL HARQ process. If an error occurs in a UL data channel of a specific HARQ process, which is transmitted in a subframe #i 611 of an n-th radio frame, transmission of a response channel for requesting retransmission for the defective channel and a retransmission control channel may take place in a DL subframe 613 after a lapse of a predetermined time t2 612.

As the TDD UL/DL configuration is changed after the subframe 613, a subframe #i 617 is changed to a DL subframe after a lapse of a time t1 615. Therefore, the retransmission of the HARQ process may not be continued in the same subframe #i 617. Although a control channel for an available UL subframe #j 618 needs to be made in a subframe 614 which is ahead of the UL subframe #j 618 by a time t1′ 616, the subframe 614 may not undergo even retransmission in the subframe #j 618 since control channel transmission is impossible as the control channel transmission is a UL subframe.

Reference numeral 620 shows a retransmission procedure according to an exemplary embodiment of the present disclosure. If an error occurs in a UL data channel of an HARQ process #i, which is transmitted in a subframe #i 621 of an n-th radio frame, transmission of a response channel for requesting retransmission for the defective channel and a control channel may take place in a subframe 623 after a lapse of a predetermined time t2 622. If the TDD UL/DL configuration is changed before the subframe 623, a control channel transmitted in the subframe 623 may include an HARQ process index or a UL subframe index to be used to in the changed TDD configuration, for the HARQ process #i. Specifically, the control channel may indicate an HARQ process index or a UL subframe index corresponding to one of subframes #j, #(j+1) and #(j+2) 625 which is behind the subframe 623 by a time t1″ 624 which is sufficient for the preparation for retransmission.

In one subframe 625 corresponding to the HARQ process index or the UL subframe index which was received in a control channel of the subframe 623, the UE may perform retransmission corresponding to the previous HARQ process #i. The HARQ process #i before the change in TDD UL/DL configuration may be switched to an HARQ process #j, #(j+1) or #(j+2) (see 626). Retransmission in the subframe 625 may be performed using the same coding rate as that used for transmission in the subframe 621 which is ahead of the change in TDD UL/DL configuration. Thereafter, the subsequent HARQ transmission may be continuously performed depending on the switched HARQ process index.

In this exemplary embodiment of the present disclosure, the TDD system may maintain the same coding rate as that used in the previous transmission during HARQ retransmission for UE, and transmit HARQ configuration information (for example, an HARQ process index or a UL subframe index) to the UE, making it possible to continuously maintain transmission of a UL data channel whose retransmission is required to match the UL HARQ process in the changed TDD configuration in the case where the TDD configuration of a radio frame is dynamically changed. As a result, as much UL data as possible can be transmitted, the maximum performance of the dynamic TDD system may be maintained, and the delay caused by retransmission of a data packet by the UE may be minimized.

According to this exemplary embodiment of the present disclosure, a Node B indicates a changed HARQ process index or a changed UL subframe index using a control channel for a UE requiring retransmission, at the point where the number of UL subframes or the number of UL HARQ processes is changed in the dynamic TDD system.

A UE may interpret some bits of the control channel depending on the NDI in the control channel. In other words, if the NDI has the same value as that in the previous control channel, the UE may interpret specific bits of the control channel as an HARQ process index (or a UL subframe index) and a retransmission version, and perform retransmission in a UL subframe corresponding to the HARQ process index or the UL subframe index. If the NDI has a value different from that in the previous control channel, the UE may interpret an MCS field in the control channel in accordance with the existing technology (for example, Table 6) since the NDI means initial transmission.

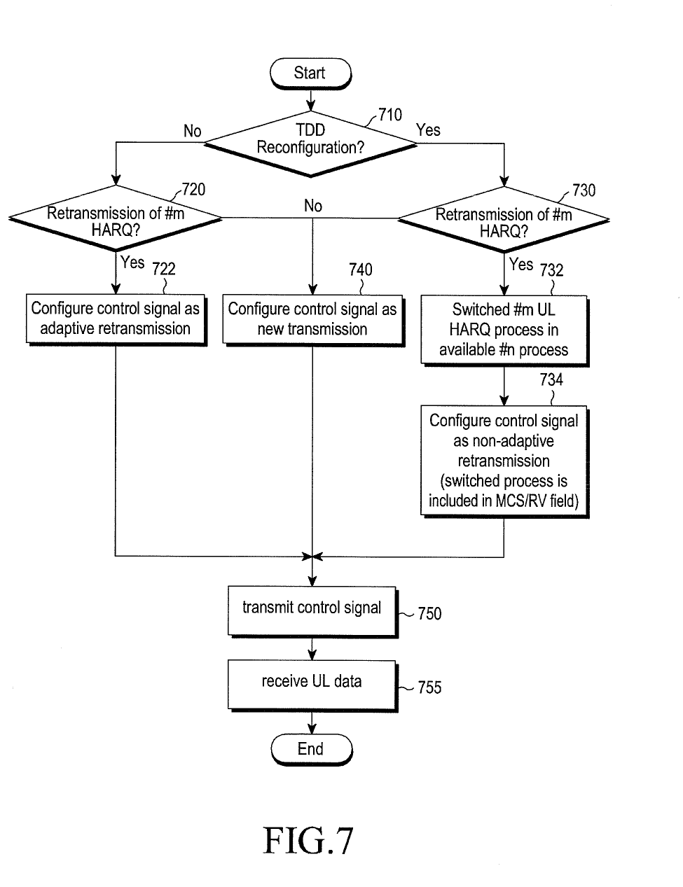

FIG. 7 illustrates an operation of a Node B according to an exemplary embodiment of the present disclosure.

Referring to FIG. 7, a Node B may determine in step 710 whether to change TDD configuration of the next radio frame, and transmit TDD UL/DL reconfiguration information to a UE, if necessary. The TDD configuration may be subject to change depending on various situations such as the amount of UL and DL data to be processed by the Node B, and the Node B's load. For example, the TDD reconfiguration information may be transmitted to UEs using system information, a DCI, or other signaling means.

If the TDD UL/DL configuration of the next radio frame is changed, the Node B may determine in step 730 whether retransmission for a first HARQ process (for example, an HARQ process #m) among the ongoing UL HARQ processes is required. Specifically, the Node B may decode UL data received in a UL subframe corresponding to the first HARQ process, and determine whether an error is detected from the decoded data. If an error is detected, the Node B may proceed to step 732, determining to request retransmission for the first HARQ process. In step 732, the Node B may determine to switch or change the first HARQ process to an HARQ process (for example, a second HARQ process) which is available due to the TDD reconfiguration. Based on the changed TDD configuration, the first and second HARQ processes may maintain the same process index, or may have different process index values. In step 734, the Node B may set an MCS field of a control channel for the first HARQ process to a value indicating the changed HARQ process index (or a UL subframe index corresponding to the second HARQ process) and a desired RV, and configure a control signal including the MCS field. In step 750, the Node B may transmit the control signal on the control channel. As a specific example, the control channel may be transmitted in a DL subframe which is ahead of a second UL subframe by a time t1. Thereafter, in step 755, the Node B may receive retransmission data corresponding to the first HARQ process from the UE in a UL subframe corresponding to the second HARQ process depending on the control signal. The retransmission data may be received using the same coding rate as that used in the previous transmission of the first HARQ process.

If determined in step 730 that retransmission for the first HARQ process is not required, the Node B may configure a control signal for initial transmission of the HARQ process defined based on the changed TDD configuration in step 740, transmit the control signal on the control channel in step 750, and receive new data of an n-th HARQ process from the UE depending on the control signal in step 755.

If determined in step 710 that the TDD configuration of the next radio frame is not changed, the Node B may determine in step 720 whether retransmission for a first HARQ process among the ongoing UL HARQ processes is required. If the retransmission is required, the Node B may configure a control signal for retransmission of the first HARQ process in step 722, and transmit the control signal to the UE using the control channel in step 750. An MCS field of the control signal may be set to be the same as that used in the initial transmission. Thereafter, in step 755, the Node B may receive retransmission data corresponding to the first HARQ process from the UE depending on the control signal.

If determined in step 720 that retransmission for the first HARQ process is not required, the Node B may configure a control signal for initial transmission of the first HARQ process in step 740, transmit the control signal on the control channel in step 750, and receive new data of the first HARQ process from the UE depending on the control signal in step 755.

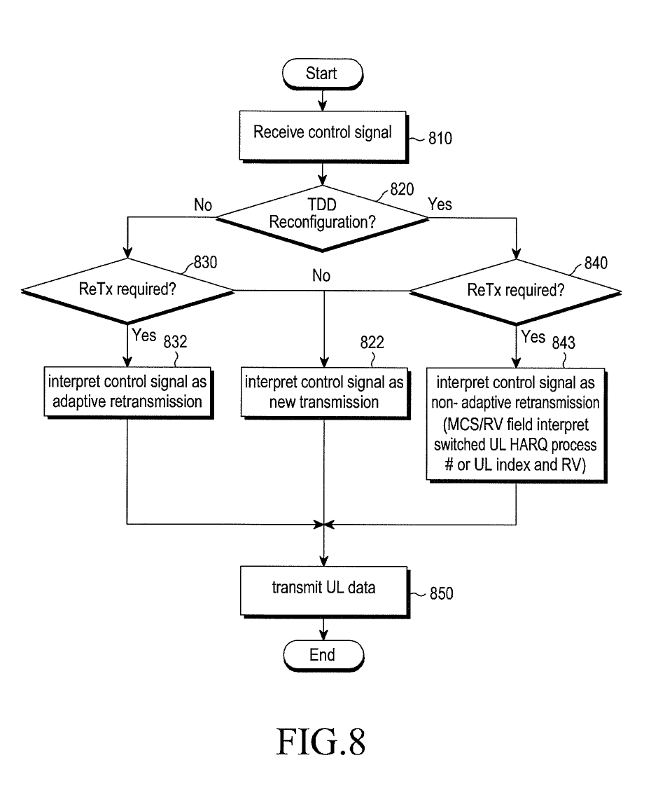

FIG. 8 illustrates an operation of a UE according to an exemplary embodiment of the present disclosure. It will be assumed herein that a UE has received information about TDD configuration of a radio frame from a Node B using system information, a DCI or other signaling means. Based on the information about TDD configuration, the UE has determined whether TDD configuration for the next radio frame is changed.

Referring to FIG. 8, in step 810, a UE may receive a control signal from a Node B on a control channel for a specific HARQ process (for example, a first HARQ process). In order to determine an interpretation scheme for the control signal, the UE may determine in step 820 whether TDD configuration of the next radio frame, to which the control signal is to be applied, is changed. If the TDD configuration of the next radio frame is changed, the UE may determine in step 840 whether retransmission for the first HARQ process is required, based on an NDI included in the received control signal.

If the retransmission is required, the UE may interpret predetermined at least some bits of an MCS field included in the received control signal as a second HARQ process index (or a UL subframe index corresponding to the second HARQ process) and an RV, and set a coding rate for retransmission to be the same as that used in the previous transmission, in step 843. In other words, the UE may perform retransmission on the first HARQ process according to the RV and the coding rate in the UL subframe corresponding to the second HARQ process in step 850, determining that the first HARQ process is switched to the second HARQ process after a change in TDD configuration.

If determined in step 840 that retransmission is not required, the UE may interpret the MCS field included in the received control signal as a coding rate for initial transmission of a new HARQ process defined based on the changed TDD configuration in step 822, and perform initial transmission of the new HARQ process depending on the control signal in step 850.

However, if determined in step 820 that TDD UL/DL configuration of the next radio frame is not changed, the UE may determine in step 830 whether retransmission for an m-th HARQ process is required, based on the NDI included in the control signal. If the retransmission is required, the UE may interpret the MCS field included in the received control signal as a coding rate for retransmission of the m-th HARQ process in step 832, and transmit retransmission data for the m-th HARQ process to the Node B depending on the control signal in step 850.

If determined in step 830 that the retransmission is not required, the UE may interpret the MCS field included in the received control signal as a coding rate for initial transmission of the first HARQ process in step 822, and transmit new data of the first HARQ process depending on the control signal in step 850.

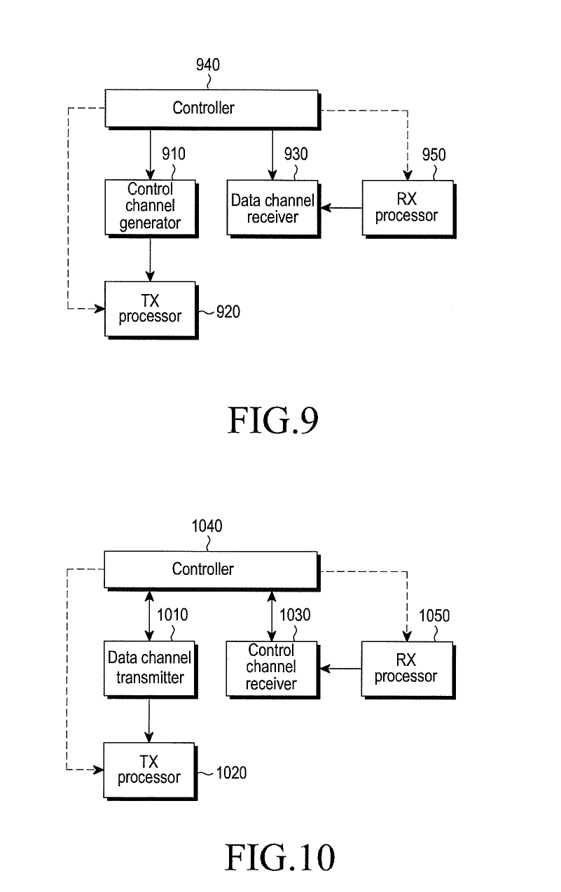

FIG. 9 illustrates a structure of a Node B apparatus according to an exemplary embodiment of the present disclosure.

Referring to FIG. 9, a controller 940 may control an operation of configuring a control channel and receiving a data channel from a UE. The controller 940 may control a control channel generator 910 to configure a control channel depending on the change in TDD UL/DL configuration of a ratio frame and the initial transmission/retransmission of UL data. The control channel generator 910, under control of the controller 940, may configure a control signal and transmit the control signal to the UE by means of a transmitting processor 920. A receiving processor 950, under control of the controller 940, may receive a data channel signal in a UL subframe and transfer the data channel signal to a data channel receiver 930. The data channel receiver 930 may demodulate and decode the data channel signal depending on the control signal.

FIG. 10 illustrates a structure of a UE apparatus according to an exemplary embodiment of the present disclosure.

Referring to FIG. 10, a receiving processor 1050, under control of a controller 1040, may transfer a control signal received from a Node B in a DL subframe, to a control channel receiver 1030. The control channel receiver 1030 may demodulate the received control signal and transfer the control signal to the controller 1040. The controller 1040 may determine a transmission point of a data channel and an HARQ process index by interpreting the control signal depending on the change in TDD configuration of the next radio frame and the initial transmission/retransmission, and configure a data channel by means of a data channel transmitter 1010. The data channel transmitter 1010, under control of the controller 1040, may configure a data channel signal and transmit the data channel signal to the Node B through a transmitting processor 1020.

As is apparent from the foregoing description, according to an exemplary embodiment of the present disclosure, a Node B may continue a UL HARQ process requiring retransmission depending on the dynamically varying TDD UL/DL configuration of the TDD system, and make the most of resources of the changed UL data channel. Conventionally, when attempting initial transmission for a data channel requiring retransmission, a UE needs to perform again the same operation of configuring data for initial transmission since the UE cannot use again the previously transmitted data, leading to an increase in the time required for complete transmission of a data packet from the UE to the Node B, causing a reduction in the system capacity. However, according to an exemplary embodiment of the present disclosure, despite the change in TDD UL/DL configuration of the dynamic TDD system, the UE may continue retransmission of an HARQ process without interruption, and the Node B may maintain the maximum system capacity.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting a control channel in a dynamic Time Division Duplex (TDD) system, the method comprising:
determining whether retransmission for a first Hybrid Automatic Retransmission Request (HARQ) process is required in a radio frame in which a TDD configuration is changed; and
in response to determining that the retransmission is required, setting information used to instruct to switch the first HARQ process to a second HARQ process in a control signal for retransmission of the first HARQ process, and transmitting the control signal to a User Equipment (UE).

2. The method of claim 1, wherein the control signal comprises a Modulation and Coding Scheme (MCS) field including at least some bits which are set as an HARQ process index or an Uplink (UL) subframe index for the second HARQ process.

3. The method of claim 2, wherein the MCS field includes remaining bits which are set as Redundancy Version (RV) information indicating a retransmission version of the first HARQ process.

4. The method of claim 1, further comprising receiving retransmission data of the first HARQ process from the UE in a receive timing of the second HARQ process depending on the control signal.

5. The method of claim 4, wherein the retransmission data is transmitted using a same MCS as that used in previous transmission.

6. A method for receiving a control channel in a dynamic Time Division Duplex (TDD) system, the method comprising:
receiving a control signal for a first Hybrid Automatic Retransmission Request (HARQ) process from a Node B;
determining whether a TDD configuration is changed in a radio frame to which the control signal is to be applied;
in response to determining that the TDD configuration is changed, determining from the control signal whether retransmission for the first HARQ process is required; and
in response to determining that the retransmission is required, interpreting predetermined bits of the control signal as information used to instruct to switch the first HARQ process to a second HARQ process.

7. The method of claim 6, wherein the control signal comprises a Modulation and Coding Scheme (MCS) field including at least some bits which are set as an HARQ process index or an Uplink (UL) subframe index for the second HARQ process.

8. The method of claim 7, wherein the MCS field includes remaining bits which are set as Redundancy Version (RV) information indicating a retransmission version of the first HARQ process.

9. The method of claim 6, further comprising transmitting retransmission data of the first HARQ process to the Node B in a transmit timing of the second HARQ process depending on the control signal.

10. The method of claim 9, wherein the retransmission data is transmitted using a same MCS as that used in previous transmission.

11. An apparatus of a Node B for transmitting a control channel in a dynamic Time Division Duplex (TDD) system, the apparatus comprising:
a controller configured to determine whether retransmission for a first Hybrid Automatic Retransmission Request (HARQ) process is required in a radio frame in which a TDD configuration is changed; and in response to determining that the retransmission is required, set information used to instruct to switch the first HARQ process to a second HARQ process in a control signal for retransmission of the first HARQ process;
a control channel generator configured to transmit the control signal to a User Equipment (UE) using a control channel corresponding to the first HARQ process; and
a data channel receiver configured to receive retransmission data of the first HARQ process from the UE in a receive timing of the second HARQ process depending on the control signal.

12. The apparatus of claim 11, wherein the control signal comprises a Modulation and Coding Scheme (MCS) field including at least some bits which are set as an HARQ process index or an Uplink (UL) subframe index for the second HARQ process.

13. The apparatus of claim 12, wherein the MCS field includes remaining bits which are set as Redundancy Version (RV) information indicating a retransmission version of the first HARQ process.

14. The apparatus of claim 11, wherein the data channel receiver is configured to receive retransmission data of the first HARQ process from the UE in a receive timing of the second HARQ process depending on the control signal.

15. The apparatus of claim 14, wherein the retransmission data is transmitted using a same MCS as that used in previous transmission.

16. An apparatus of a User Equipment (UE) for receiving a control channel in a dynamic Time Division Duplex (TDD) system, comprising:
a control channel receiver configured to receive a control signal for a first Hybrid Automatic Retransmission Request (HARQ) process from a Node B;
a controller configured to determine whether a TDD configuration is changed in a radio frame to which the control signal is to be applied, determine from the control signal whether retransmission for the first HARQ process is required in response to determining that the TDD configuration is changed, and interpret predetermined bits of the control signal as information used to instruct to switch the first HARQ process to a second HARQ process in response to determining that the retransmission is required; and
a data channel transmitter configured to transmit retransmission data of the first HARQ process to the Node B in a transmit timing of the second HARQ process depending on the control signal.

17. The apparatus of claim 16, wherein the control signal comprises a Modulation and Coding Scheme (MCS) field including at least some bits which are set as an HARQ process index or an Uplink (UL) subframe index for the second HARQ process.

18. The apparatus of claim 17, wherein the MCS field includes remaining bits which are set as Redundancy Version (RV) information indicating a retransmission version of the first HARQ process.

19. The apparatus of claim 16, wherein the data channel transmitter is configured to transmit retransmission data of the first HARQ process to the Node B in a transmit timing of the second HARQ process depending on the control signal.

20. The apparatus of claim 19, wherein the retransmission data is transmitted using a same MCS as that used in previous transmission.
